(19) United States
(12) Patent Application Publication
(10) Pub. No.: US 2005/0179336 A1
(43) Pub. Date: Aug. 18, 2005

(54) Axial gap electric rotary machine

(76) Inventors: Masahiro Hasebe, Aichi (JP); Masami Ishikawa, Aichi (JP); Akira Mizuno, Aichi (JP); Yoji Takeda, Osaka (JP); Masayuki Sanada, Osaka (JP)

Correspondence Address: LORUSSO, LOUD & KELLY, 3137 Mount Vernon Avenue, Alexandria, VA, 22305, US

(21) Appl. No.: 10/983,892

(22) Filed: Nov. 9, 2004

(30) Foreign Application Priority Data
Nov. 17, 2003 (JP) 2003-387267

(51) Int. Cl. H02K 1/00; H02K 3/00

(52) U.S. Cl. 310/268

(57) ABSTRACT

An axial gap electric rotary machine includes a rotor and a stator that face each other across an axial gap. The rotor is provided with salient poles and permanent magnets that are positioned separately around the circumference of the rotor. Accordingly, north poles and south poles are alternately formed on a surface of the rotor that faces the stator. The magnetic resistance of a magnetic path that passes through the permanent magnets is larger than the magnetic resistance of a magnetic path that does not pass through the permanent magnets. Accordingly, the axial gap electric rotary machine is able to function as a reluctance motor and as a permanent magnet synchronous motor using a single set of facing surfaces of the rotor and the stator, respectively.

### CROSS-REFERENCE TO RELATED APPLICATIONS

This application claims, under 35 USC 119, priority of Japanese Application No. 2003-387267 filed Nov. 17, 2003. Related subject matter is disclosed and claimed by the present inventors in application Ser. No. 10/______ (Attorney Docket No. EQU-C490) for “AXIAL GAP ELECTRIC ROTARY MACHINE”, filed on even date herewith.

### INCORPORATION BY REFERENCE

The disclosure of Japanese Patent Application No. 2003-387267 filed on Nov. 17, 2003 including the specification, drawings and abstract is incorporated herein by reference in its entirety.

### BACKGROUND OF THE INVENTION

1. Field of the Invention

The present invention relates to a rotary electric machine such as a motor or generator. Particularly, the present invention relates to an axial gap rotary electric machine in which a rotor and a stator face each other and are axially spaced across the axial gap.

2. Description of the Related Art

One known axial gap motor has a disc-type rotor and a stator arranged at an end face of the rotor facing and axially spaced from the rotor with a gap therebetween. The rotational driving force of the motor is a magnetic force that acts between the surface of the rotor and the surface of the stator that face each other across the axial gap. The axial gap motor is advantageous in that it has a smaller axial dimension compared to a conventional radial-type motor which has a cylindrical rotor and an annular stator which surrounds the outer cylindrical surface of the rotor.

Conventional rotors used in axial gap motors include: a reluctance-type motor in which recesses and convex portions are formed in an end face of a magnetic member facing a stator; a permanent-magnet type motor having a north pole and a south pole that act over rotationally driven magnetic poles of the stator; and an induction type motor in which an inductor is radially arranged (see paragraph 0022 of Japanese Patent Laid-Open Application No. H10-80113). Further, some axial gap motors utilize a combination of the above configurations, as exemplified by that disclosed in Japanese Patent Laid-Open Application No. H11-218130, in which a permanent magnet is arranged on one axial end face of a disc-rotor and a recess portion and a convex portion made of a magnetic material are formed on the other end face. The motor disclosed in Japanese Patent Laid-Open Application No. H11-218130 acts as a permanent magnet synchronous motor that generates torque between the stator having windings and the permanent magnets on a surface of the rotor. At the rotor's other surface on which the recess and convex portions are formed, the motor acts as a reluctance motor that generates reluctance torque using (i) magnetic force between the convex and recess portions and (ii) a magnetic field generated by the windings of the stator (see Paragraph 0003 of Japanese Patent Laid-Open Application No. H11-218130). Note that the reluctance torque becomes larger as the difference in magnetic resistance between a magnetic path that passes through a recess portion (q-axis magnetic path) and a magnetic path that passes through a convex portion (d-axis magnetic path), that are formed between the rotor and the stator, becomes larger.

The aforementioned motors as disclosed in Japanese Patent Laid-Open Application No. H10-80113 and Japanese Patent Laid-Open Application No. H11-218130 are configured to function as a reluctance motor at one surface of the rotor, and to function as a permanent magnet synchronous motor at the other surface. Such rotors are a combination of a rotor for a reluctance motor and a rotor for a permanent magnet, thereby requiring an increase in the axial dimension.

Furthermore, the conventional reluctance-type axial gap motor in which convex and recess portions are provided on the rotor requires the projection of the convex portion (salient pole) to be extended in order to increase the difference in magnetic resistance between the magnetic path that passes through the recess portion and that of the magnetic path that passes through the convex portion. However, when the dimension of the projection is increased, the axial dimension of the motor is also increased.

### SUMMARY OF THE INVENTION

It is a primary object of the present invention to provide an axial gap electric rotary machine capable of functioning as a reluctance-type motor and as a permanent magnet synchronous motor at a single side surface of a rotor. Further, it is another object of the present invention to provide an axial gap electric rotary machine which combines the functions of both a reluctance-type motor and a permanent magnet synchronous motor, and which is axially compact.

In order to achieve the aforementioned objects, an axial gap electric rotary machine according to a first aspect of the present invention includes a rotor and a stator, with the rotor and the stator facing each other across an axial gap therebetween. The surface of the rotor that faces the stator has salient poles made of magnetic material and permanent magnets that are circumferentially spaced thereon.

The axial gap electric rotary machine according to the first aspect of the present invention may be configured such that the salient poles and the permanent magnets occupy different positions on the circumference of the rotor. It is preferable, in this case, that the salient poles be integrally formed with a back yoke made of magnetic material and that the permanent magnets be embedded in recesses between adjacent salient poles.

Alternatively, in the axial gap electric rotary machine according to the first aspect of the present invention the positions of the salient poles may coincide with the circumferential positions of the permanent magnets. In this case, the permanent magnets are positioned between the salient poles and the back yoke. The salient poles may be pole shoes made of magnetic material that are attached to the permanent magnets.

One embodiment of the axial gap electric rotary machine of the present invention has rotors at each axial end of the stator. In such an embodiment the stator may be arranged such that cores of the stator are circumferentially aligned, with magnetic poles of the cores being axially orientated.

In another embodiment the electric rotary machine according to the present invention includes a rotor and stators arranged at each axial end of the rotor with axial gaps therebetween. In this embodiment the permanent magnets are arranged around the circumference of the rotor with the magnetic poles of each permanent magnet being axially orientated and the permanent magnets extending axially through the rotor. Pole shoes of magnetic material may be arranged on the magnetic pole surfaces of the permanent magnets.

In the axial gap electric rotary machine according to the first aspect of the present invention the magnetic resistance of the q-axis is proportional to the air gap, and the magnetic resistance of the d-axis is proportional to the air gap plus thickness of the magnet. The difference in magnetic resistance between the d-axis and the q-axis, determined by the thickness of the magnet, is utilized to generate motor reluctance torque. Further, because the axial gap electric rotary machine is capable of generating reluctance torque at the surface having the permanent magnets facing the rotor, both reluctance torque and permanent magnet torque are generated at the same facing surfaces of the rotor and the stator. Accordingly, high torque and high rotational speed can be achieved.

Further, in the embodiment in which the salient poles and the permanent magnets occupy different positions around the circumference of the rotor, the salient poles and the permanent magnets are circumferentially aligned. Location of the permanent magnets in recesses between the salient poles provides a permanent magnet arrangement by which the axial dimension of the rotor can be minimized. Moreover, in the axial gap rotating electric machine in which the salient poles are integrally formed with the back yoke and the permanent magnets are embedded in recesses between the salient poles, the axial dimension of the salient poles is equal to only the axial dimension of the permanent magnets which is required for a permanent magnet synchronous motor.

On the other hand in an embodiment in which the circumferential positions of the salient poles are the same as positions of the permanent magnets, the configuration of the rotor is simplified, thereby allowing machining of the rotor to be performed more easily. Moreover, in the axial gap electric rotary machine in which the permanent magnets are arranged between the salient poles and the back yoke, the height of the salient poles can be increased by changing the thickness of the permanent magnets.

In an embodiment in which rotors are arranged on both sides of the stator a high output can be generated with an extremely compact configuration. Furthermore, in the axial gap rotating electric machine in which the windings with the stator core are circumferentially aligned, with the magnetic poles thereof being axially directed, need for a back yoke for the stator is eliminated and thus the thickness of the electric rotary machine can be reduced.

In the embodiment of the axial gap electric rotary machine in which the stators are arranged at both axial ends of the rotor, a closed magnetic path can be formed which passes through the stator and through the inside of the stator. Accordingly, need for a back yoke for the rotor is eliminated, and thus the thickness of the electric rotary machine can be reduced.

In the embodiment in which the permanent magnets are circumferentially arranged on the rotor, with the magnet poles of each permanent magnet being axially directed and the permanent magnets passing axially through the rotor, and pole shoes made of magnetic material being arranged on the surfaces of the permanent magnets at the magnetic poles, the q-axis magnetic path is closed and passes through the pole shoes, without passing through the interior of the rotor. Therefore, magnetic resistance in the q-axis magnetic path can be further reduced. Accordingly, the difference in magnetic resistance between the d-axis and the q-axis is increased, whereby a larger reluctance is generated.

The present invention may be applied to a motor, a generator, or a motor generator. The present invention is particularly effective when applied where the axial dimension is strictly limited, for example, a wheel motor of an electric vehicle, or a motor or generator which is arranged coaxially or on an axis that is parallel to the axis of a transversally-mounted engine in a hybrid vehicle drive unit.

### BRIEF DESCRIPTION OF THE DRAWINGS

FIG. 1 is a partially expanded perspective view of an axial gap electric rotary machine according to a first embodiment of the present invention;

FIG. 2 is an expanded schematic view, partially in cross-section, showing the principle structure of the stator and rotor of the first embodiment;

FIG. 3 is a partially exploded perspective view of an axial gap electric rotary machine according to a second embodiment of the present invention;

FIG. 4 is an expanded schematic view, partially in cross-section, showing the principle structure of the stator and rotor of the second embodiment;

FIG. 5 is a partially exploded perspective view of an axial gap electric rotary machine according to a third embodiment of the present invention;

FIG. 6 is an expanded schematic view, partially in cross-section, showing the principle structure of the stator and rotor of the third embodiment;

FIG. 7 is a schematic cross-sectional view of the third embodiment showing specific detail;

FIG. 8 is an expanded partial cross-sectional view of the stator and rotor of a fourth embodiment;

FIG. 9 is an expanded partial cross-sectional view of the stator and rotor of a fifth embodiment;

FIG. 10 is an expanded partial cross-sectional view of the stator and rotor of a sixth embodiment; and

FIG. 11 is an expanded partial cross-sectional view of the stator and rotor of a seventh embodiment.

### DETAILED DESCRIPTION OF THE PREFERRED EMBODIMENTS

An axial gap electric rotary machine according to the present invention has an overall configuration in which rotors are provided on both axial sides of a stator. In this case, there may be one stator or a plurality of stators. With this configuration, respective back yokes of the rotors that are on each side of the stator can also function as cores that form a closed magnetic path. Therefore, it is possible to provide an extremely thick electric rotary machine that eliminates the necessity of providing a back yoke for the stator. This electric rotary machine is capable of generating an extremely high output since it can function as a reluctance-type motor and a permanent-magnet synchronous motor simultaneously on both sides of the stator.

First Embodiment

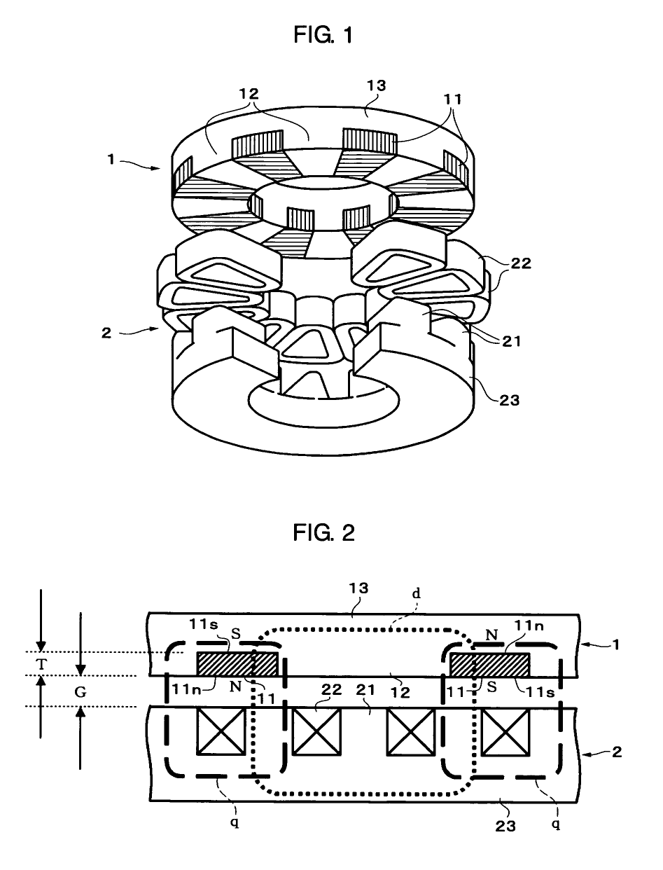

FIGS. 1 and 2 show a first embodiment of an axial gap electric rotary machine in accordance with the present invention as including a disc-like rotor 1 and a stator 2 facing each other and axially spaced to define a gap therebetween. The rotor 1 is provided with at least one salient pole 12 made of a magnetic material and at least one permanent magnet 11 on the side of the rotor that faces the stator 2. The permanent magnet 11 and the salient pole 12 are circumferentially positioned separately from each other. The salient poles 12 are integrally formed with a back yoke 13 which is made of a magnet material and serves as a rotor core. Each permanent magnet 11 is embedded in a recess between adjacent salient poles 12. The salient poles 12 and the permanent magnets 11 are positioned so as to be adjacent to each other with a spacing (interval) therebetween.

As shown in FIG. 2, the permanent magnets 11 are positioned such that 1) their magnetic poles are aligned in parallel with the axis of the rotor, in other words, magnetic surfaces 11n and 11s are arranged along and parallel to the surfaces of the disc of the rotor 1, and 2) the magnetic poles N and S of the magnets 11 that are adjacent to each other are opposite and alternate around the circumference. In this embodiment as shown in FIG. 1, the radially inward arc side surface and the radially outward arc side surface of each permanent magnet 11 and salient pole 12 have the same curvatures as the back yoke 13. The flat surfaces which extend between the radially inward arc side surface and the radially outward arc side surface are fan-shaped so that they expand radially outward from the center of the electric rotary machine. The permanent magnets 11 and the salient poles 12 are substantially equal in axial thickness. By adopting the aforementioned design, it is possible to minimize the axial thickness of the circular-disc type rotor despite the fact that the rotor 1 is provided with the salient poles 12, because the permanent magnets 11 and the salient poles 12 are alternately and circumferentially arranged. In this embodiment, the overall axial thickness of the rotor 1 is equal to the thickness of the permanent magnet 11 plus the thickness of the back yoke 13.

The stator 2 which faces the rotor 1 with a gap G therebetween is made of a magnetic material and has a circular-disc shape with inner and outer circumferential diameters that are substantially the same as those of the circular-disc shaped rotor 1. The stator 2 has wedge-shaped projections 21 with rounded corners projecting from one end face thereof, i.e., from the end face which faces the rotor 1 across gap G. The projections are arranged spaced around the circumference. A winding 22 is wound around the peripheral surface of each projection 21. Accordingly, the projections 21 serve as the core of the stator 2 and the disc-shaped circular portion forms a back yoke 23. Note that FIG. 1 has a front portion of some elements cut away to better show other components. This approach to illustration is adopted in all perspective views of all embodiments to be described later.

According to the first embodiment, as shown in FIG. 2, a magnetic path between the rotor 1 and the stator 2 includes 1) a d-axis magnetic path (shown by a bold dotted line) that passes through the permanent magnet 11; and 2) a q-axis magnetic path (shown by a bold broken line) that passes through only the cores made of magnetic material, that is, a magnetic path that does not pass through the permanent magnet 11. Since the permanent magnet 11 has a large magnetic resistance, magnetic resistance of the d-axis path and that of the q-axis path will be different. The difference corresponding to the thickness T of the permanent magnet 11, i.e., the distance between the magnetic pole surfaces. A conventional axial gap electric rotary machine that generates reluctance torque has a difference in magnetic resistance between that of the d-axis magnetic path and that of the q-axis magnetic path, in accordance with the height of the salient poles provided on a surface of the rotor. In this first embodiment, on the contrary, the difference in magnetic resistance between the d-axis path and the q-axis path is caused by dividing the magnetic path into 1) the d-axis magnetic path which passes through the permanent magnets 11 which are mounted in recesses and 2) the q-axis magnetic path that does not pass through the permanent magnets 11 but, rather, through the salient poles where no permanent magnet is located. Further, the axial gap electric rotary machine according to the first embodiment can serve as a permanent magnet synchronous motor for generating torque (hereinafter referred to as “permanent magnet synchronous torque”), due to the permanent magnets 11 provided in the recesses.

Because the axial gap electric rotary machine according to the first embodiment is capable of simultaneously generating reluctance torque and permanent magnet synchronous torque at the facing surfaces of the rotor 1 and the stator 2, it is capable of outputting a larger torque than a comparable size motor of the related art wherein reluctance torque or permanent magnet synchronous torque is generated on one or the other axial sides of the rotor. Accordingly, the torque obtained using one side of the axial gap electric rotary machine according to the first embodiment is substantially equivalent to that generated by conventional motors which generate torque from both sides. It should be noted that in the field of motor technology the definitions of the d-axis and the q-axis for the reluctance motor and the permanent magnet motor may be reversed. Therefore, in a motor which generates both reluctance torque and permanent magnet torque, the definitions of the d-axis path and the q-axis path are not fixed. In the present invention the difference in magnetic resistance between the d-axis magnetic path and that of the q-axis magnetic path is increased. Therefore, even if the definitions of the d-axis and the q-axis are reversed, the effect of the present invention as described herein is not affected.

Second Embodiment

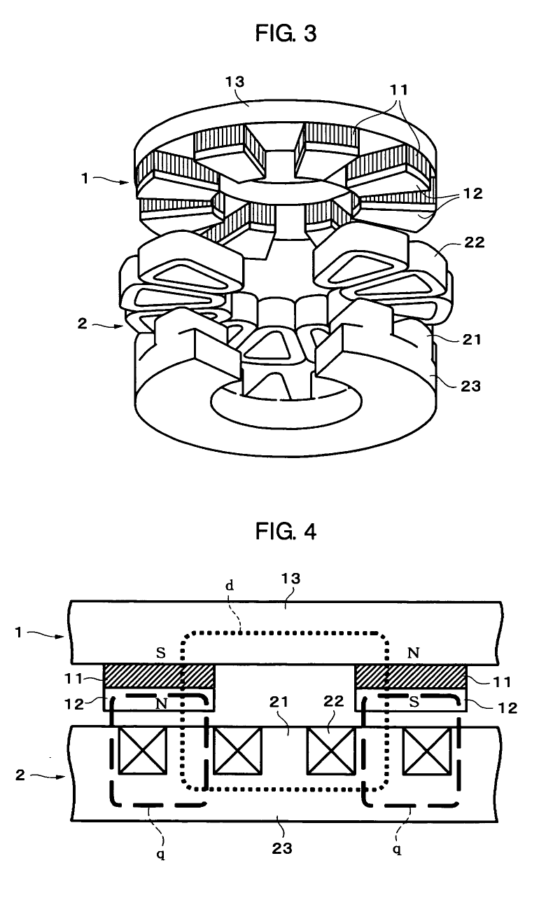

Next, a second embodiment will be explained with reference to FIGS. 3 and 4. The second embodiment is an example where the circumferential positions of the salient poles 12 and those of the permanent magnets 11 are the same. In this second embodiment, the permanent magnet 11 is axially positioned between the salient pole 12 and the back yoke 13. In this second embodiment, the salient pole 12 is a plate-like member having the same shape as the flat tabular shape of the permanent magnet 11. Further, the salient pole 12 is configured as a pole shoe made of a magnetic material that is attached to the permanent magnet 11. Since the other structural elements are the same as those in the first embodiment, the same reference numerals are used to denote corresponding elements and an explanation thereof will be omitted.

As shown in FIG. 4, the magnetic path between the rotor 1 and the stator 2 can be seen as divided into a d-axis magnetic path (shown by a bold dotted line) that passes through the permanent magnet 11 and a q-axis magnetic path (shown by a bold broken line) that passes through only the core of magnetic material, that is, a magnetic path that does not pass through the permanent magnet 11. Further, since the permanent magnet 11 has a large magnetic resistance, the difference in magnetic resistance between the d-axis path and the q-axis path is in accordance with the thickness of the permanent magnet 11, i.e., the distance between the magnetic pole surfaces. More specifically, when the axial gap electric rotary machine of this second embodiment acts as a motor, reluctance torque is generated is by interaction of a magnetic flux which passes through the q-axis magnetic path via the pole shoe 12 and a magnetic flux which passes through the d-axis magnetic path via the permanent magnets. Further, the permanent magnets cause permanent magnet torque to be generated at the facing surfaces of the rotor 1 and the stator 2. Accordingly, in the present embodiment as well, both reluctance torque and permanent magnet torque can be generated at the single interface between the rotor 1 and the stator 2 and, thus, an axial gap motor is realized that outputs high torque and revolves at a high rotational speed. Furthermore, in the second embodiment, unlike the first embodiment, it is not necessary to embed the permanent magnets, whereby the configuration of the rotor can be simplified.

Third Embodiment

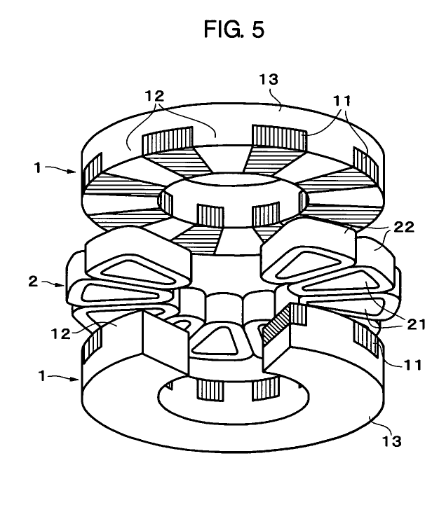

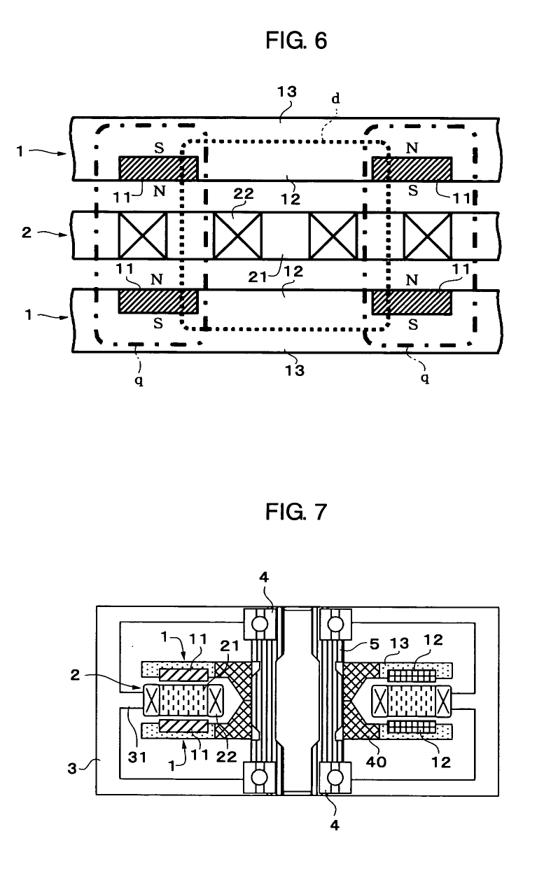

Next, a third embodiment will be explained with reference to FIGS. 5 and 6. The third embodiment has two rotors 1, similar to those used in the first embodiment, disposed at axially opposing sides of the stator 2 with the windings 22. In this third embodiment, the configuration of the stator 2 is also different from that of the first embodiment. As shown in FIG. 5, the stator 2 is formed by winding each coil 22 around a core (hereinafter referred to as “stator core”) 21, the stator cores being circumferentially aligned. More specifically, each stator core 21 has a coil (winding) 22 wound around its peripheral surface and has a shape similar to that of the projection in the first embodiment. The stator cores 21 are connected to each other in a circle to provide circular-disc shaped stator 2 in overall configuration, without a back yoke.

FIG. 6 shows the d-axis magnetic path and the q-axis magnetic path that generate reluctance torque in the third embodiment. As shown in FIG. 6, in this third embodiment, the d-axis magnetic path passes through the permanent magnets 11 in both the upper and lower rotors 1. Therefore, the difference between the magnetic resistance of the d-axis magnetic path and that of the q-axis magnetic, which does not pass through the magnets, becomes larger than that of the first embodiment, that is, the reluctance torque is further increased. In addition, the axial gap electric rotary machine according to the third embodiment is capable of generating both reluctance torque and permanent magnet synchronous torque at both axial ends of the stator 2. Therefore, the axial gap electric rotary machine according to the third embodiment is capable of generating an extremely large torque as compared to a conventional axial gap motor. Furthermore, the arrangement of the rotors 1 at both ends (or “sides”) of the stator 2 eliminates the need for a back yoke for the stator 2. This is because a closed magnetic path can be formed by the stator 2 and the iron cores of the rotors 1, even though there is no back yoke. Therefore, in this third embodiment, output torque per motor unit volume can be increased by an amount corresponding to the size of the back yoke which is required in the conventional art.

As shown in FIG. 7, in the third embodiment the rotors 1 and the stator 2 are housed in a housing 3. The stator 2 is arranged on a support 31 that projects radially inward from a peripheral wall of the housing 3, such that the outer periphery of the stator 2 is supported by the support 31. Rotational shafts 5 are arranged at both end walls of the housing 3, such that both ends of the rotational shafts 5 are supported by the peripheral walls of the bearings 4. Further, a pair of the rotors 1 are arranged on the outer periphery of the rotational shaft 5 and are secured thereto against rotation relative to the rotational shaft 5, and sandwich the stator 2. The figure shows a radial section that passes through a permanent magnet and a radial section that passes through a salient pole. As shown in the drawing, each rotor 1 is coupled to the rotational shaft 5 via a rotor hub 40. Each rotor hub 40 is arranged at an inner peripheral side (that is, radially inward of the back yoke 13). In FIG. 7, the cross-sections with a vertical broken-line pattern represent the stator core 21; the sections with an X mark represent the stator windings 22; the sections with a vertical-line pattern represent the rotational shaft 5; the sections with a hatched pattern represent the permanent magnets 11 of the rotor 1; the sections with a vertical and horizontal grid pattern represent salient pole 12 of the rotor 1; the sections with a dotted pattern represent the back yoke 13 of the rotor 1; and the sections with the striped grid pattern represent the rotor hubs 40. Note that the rotor hub 40 secures (1) the permanent magnets 11 of the rotor 1, (2) the iron core 12 of the rotor 1, and (3) the back yoke 13 of the rotor to the rotational shaft 5. Therefore, the rotor hub 40 is made of a non-magnetic material so as to prevent the magnetic path between the paired rotors 1 from being short circuited.

Fourth Embodiment

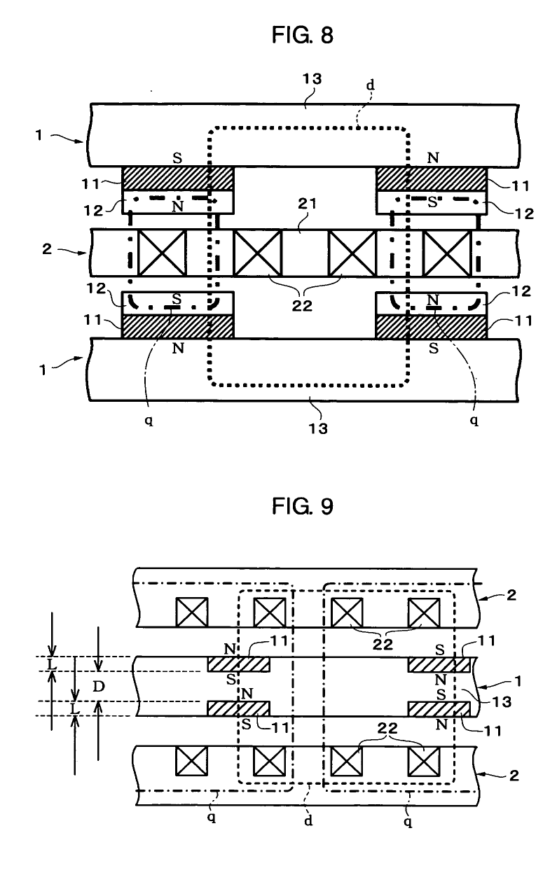

FIG. 8 shows a fourth embodiment in the form of a double-rotor type electric rotary machine combining rotors of the type used in the second embodiment with the same stator as in the third embodiment. Since other structural elements of the fourth embodiment are the same as those in the preceding embodiments, the same reference numerals are used to denote corresponding members and explanation thereof is omitted. The configuration of the fourth embodiment not only provides the effect realized by the second embodiment, namely, simplification of the rotor configuration, but also eliminates the necessity of providing a back yoke for the rotor, thereby allowing the thickness of the rotor to be reduced. This is because a closed magnetic path can be formed by the stator 2 and either of the pole shoes 12 of the rotors 1 on both sides of the stator 2 or the core of the rotor 1.

Fifth Embodiment

FIG. 9 shows a fifth embodiment which employs a double-stator type electric rotary machine. In this fifth embodiment, permanent magnets 11 are arranged at both axial sides of the rotor 1 and stators 2 are arranged at both axial sides of the rotor 1. In this arrangement, the permanent magnets 11 that are adjacent to each other are arranged such that their poles are reversed in the axial direction. Further, the permanent magnets 11 are arranged such that their magnetism is directed in the same direction when the rotor 1 is viewed along its axis. More specifically, the permanent magnets 11 are arranged such that one side of the rotor 1 becomes the north pole and the other side, that is, the axially opposite side, becomes the south pole. In the fifth embodiment, both permanent magnet synchronous torque and reluctance torque are generated at both sides of the single rotor, whereby the electric rotary machine provides a high torque output.

Sixth Embodiment

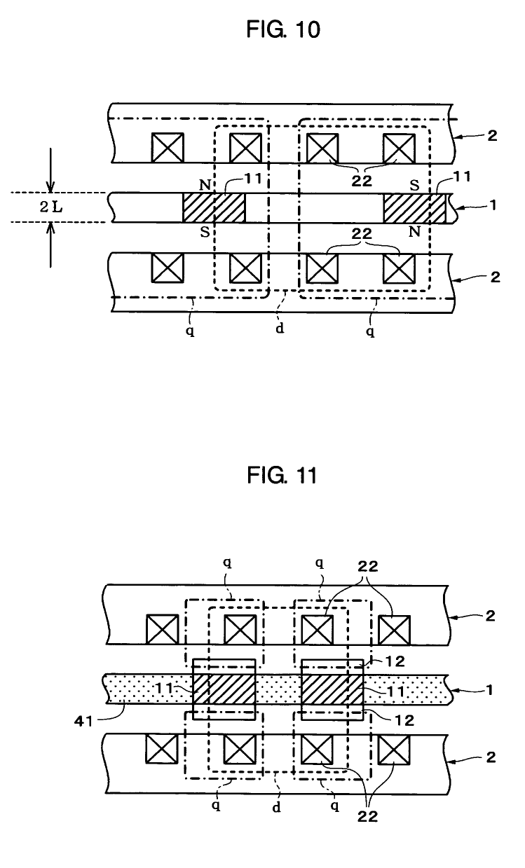

Note that the fifth embodiment as shown in FIG. 9 combines two of the configurations of the second embodiment (refer to FIGS. 1 and 2). More specifically, two rotors 1 are integrally combined, back to back. Therefore, when the thickness of the permanent magnet 11 is L and the thickness of the back yoke 13 is D, the thickness of the rotor 1 is expressed as 2L+D. The magnetic path according to the fifth embodiment (the magnetic path as shown by a broken line is FIG. 9) passes through the rotor 1 in the axial direction and passes through the inside of the stators 2 that are on the both sides of the rotor 1. Therefore, it is apparent that the back yoke 13, i.e., that portion of the thickness of the rotor 1 expressed as D in FIG. 9 is not required for forming the magnetic path. Therefore, the sixth embodiment as shown in FIG. 10 adopts a configuration in which the back yoke is eliminated. In the sixth embodiment, the permanent magnet 11 passes through the entire width of the rotor 1, with the magnetic poles thereof directed in parallel with the axis of the rotor 1. Accordingly, when the same magnet as in the fifth embodiment with the thickness L is used, the thickness of the rotor 1 can be reduced to 2 L, thereby reducing the axial thickness of the rotor. Further, in the sixth embodiment, it is possible to reduce the length of the magnetic path by an amount corresponding to the thickness D in the fifth embodiment as shown in FIG. 9, thereby reducing the magnetic resistance and providing a more efficient motor.

Seventh Embodiment

The seventh embodiment shown in FIG. 11 is based on the configuration of the sixth embodiment, and respective pole shoes 12 which are the same as those of the second embodiment are arranged on both sides of the permanent magnet 11. More specifically, in the seventh embodiment, the plurality of the permanent magnets 11 are circumferentially arranged around the rotor 1 and pass through the entire width of the rotor 1, with their magnetic poles 11 being directed parallel to the axis. The pole shoes 12 made of magnetic material are arranged on the magnetic pole faces of the permanent magnets 11. This seventh embodiment provides the same effect as the sixth embodiment. Further, the q-axis magnetic path (shown by a dashed line in FIG. 11) is closed, and passes through the pole shoes 12 which are on the surfaces of the magnet 11, without passing through the interior of the rotor 1. Therefore, it is possible to further reduce the length of the q-axis magnetic path as compared with the sixth embodiment. Accordingly, magnetic resistance of the q-axis magnetic path is further reduced, whereby the difference in magnetic resistance between the d-axis magnetic path (showed by the broken line in FIG. 11) and the q-axis magnetic path is reduced, thereby allowing larger reactance torque to be generated. Note that in the seventh embodiment, the magnetic flux does not need to pass through the inside of the rotor I except for the pole shoe 12 and the permanent magnet 11. Therefore, it is desirable that a magnet support member 41 (as shown by a dotted pattern in FIG. 11), which is that portion of the rotor 1 excluding the pole shoe 12 and the permanent magnet 11, be made of a non-magnetic material. It is desirable to use a non-magnetic material for the magnet support member 31 because it reduces the possibility that an unnecessary magnetic path will form, that is, the possibility that leakage flux will be generated thereby reducing motor efficiency.

Although a permanent magnet having a fan shape is adopted in the embodiments described above, the shape of the permanent magnet may be changed. To facilitate machining of the magnet, for example, the permanent magnet 11 may be formed in a bar shape with a rectangular cross section. Since rotational torque generated by the permanent magnets 11 depends on the size and arrangement of the permanent magnets 11, it is possible to change the permanent magnet torque by changing the arrangement of the permanent magnets 11. Particularly, when the size of the permanent magnets 11 is increased, counter-electromotive voltage at high-speed rotation increases, making high-speed rotation difficult. In order to address this problem, permanent magnets 11 with a smaller volume than the volume of the space between adjacent rotor cores can be adopted, whereby the counter-electromotive voltage can be reduced and a motor suitable for high-speed rotation can be realized. Permanent magnets divided into a plurality of pieces may be arranged between the salient poles with the same effect. Further, since such division of the permanent magnets also reduces eddy currents generated in the permanent magnet, the motor becomes even more efficient.

Note that all of the embodiments described above, the permanent magnets do not contact the adjacent rotor core. Therefore, a gap may be provided between the rotor core and the permanent magnets. Furthermore, the present invention achieves the same effects and advantages, regardless of the method of winding the coil (the windings) around the stator such as distributed winding, concentrated winding or the like.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. An axial gap electric rotary machine comprising:
at least one rotor having at least one surface with salient poles made of magnetic material and permanent magnets, the salient poles and the permanent magnets being positioned around the circumference of the rotor; and
at least one stator, said one stator facing said one surface of said rotor with an axial gap therebetween.

2. The axial gap electric rotary machine according to claim 1, wherein the salient poles and the permanent magnets occupy different circumferential positions on said rotor.

3. The axial gap electric rotary machine according to claim 2, wherein the salient poles are integrally formed with a back yoke made of magnetic material and the permanent magnets are embedded in recesses between adjacent salient poles.

4. The axial gap electric rotary machine according to claim 1, wherein the salient poles and the permanent magnets occupy the same circumferential positions.

5. The axial gap electric rotary machine according to claim 4, wherein each permanent magnet is positioned between a salient pole and the back yoke.

6. The axial gap electric rotary machine according to claim 5, wherein the salient poles are in the form of pole shoes made of magnetic material that are attached to the permanent magnets.

7. The axial gap electric rotary machine according to claim 1, further comprising:
a second rotor having a second surface with salient poles and permanent magnets positioned around the circumference of the second rotor, said first and second surfaces facing, respectively, axially opposing surfaces of said stator.

8. The axial gap electric rotary machine according to claim 1, further comprising:
a second stator, said one stator and said second stator being respectively positioned at axially opposite sides of the rotor; and
wherein each of said axially opposite sides of said rotor is formed as a surface with salient poles of a magnetic material and permanent magnets arranged around the circumference of the rotor.

9. An axial gap electric rotary machine comprising:
a rotor; and
stators that are arranged respectively facing axially opposite sides of the rotor with gaps therebetween, and
wherein the rotor is provided with magnetic elements and permanent magnets that are alternately arranged around the circumference of the rotor, and
wherein the permanent magnets pass through the rotor parallel to the axis of the rotor.

10. An axial gap electric rotary machine comprising:
a rotor; and
stators that are arranged respectively facing axially opposite sides of the rotor with gaps therebetween,
wherein permanent magnets are arranged on the rotor around the circumference of the rotor with their magnet poles being axially directed,
wherein the permanent magnets pass through the rotor parallel to the axis of the rotor, and
wherein pole shoes made of magnetic material are arranged on surfaces of the magnetic poles of the permanent magnets.
